(19) United States
(12) Patent Application Publication
(10) Pub. No.: US 2024/0243368 A1
(43) Pub. Date: Jul. 18, 2024

(54) POWER STORAGE SYSTEM, POWER SUPPLY, DRIVING DEVICE, POWER CONTROL DEVICE, AND METHOD FOR EQUALIZING POWER STORAGE STATUSES

(71) Applicant: Ryutaro NOZU, Kanagawa (JP)

(72) Inventor: Ryutaro NOZU, Kanagawa (JP)

(21) Appl. No.: 18/575,888

(22) PCT Filed: Jun. 30, 2022
(86) PCT No.: PCT/IB2022/056095

§ 371 Date: Jan. 2, 2024

(30) Foreign Application Priority Data
Jul. 8, 2021 (JP) 2021-113622

(51) Int. Cl. H01M 10/36; H01M 4/02; H01M 4/505; H01M 10/0525; H01M 10/30; H01M 10/44; H02J 7/00

(52) U.S. Cl. CPC H01M 10/36; H01M 10/0525; H01M 10/30; H01M 10/441; H02J 7/0014; H01M 2004/028; H01M 4/505

(57) ABSTRACT

A power storage system includes a first cell group including a plurality of first cells connected in series. Each of the plurality of first cells is a non-aqueous secondary battery. The power storage system includes a second cell group including a plurality of second cells connected in series. Each of the plurality of second cells is an aqueous secondary battery. One or more cells of the plurality of second cells included in the second cell group are connected in parallel to a corresponding one of the plurality of first cells included in the first cell group.

### TECHNICAL FIELD

Embodiments of the present disclosure relate to a power storage system, a power supply, a driving device, a power control device, and a method for equalizing power storage statuses.

### BACKGROUND ART

In recent years, there has been a rise in demand for lithium-ion secondary batteries to be used as power supplies (power sources) for portable devices such as video cameras and laptop computers, and as power supplies (power sources) for hybrid vehicles, electric vehicles, and power storage (electric power storage, energy storage), for example. A lithium-ion secondary battery is a storage battery having high energy density per weight, and applicable to a use case of high driving voltage by being used as an assembled battery in which a plurality of cells is connected in series.

However, in an assembled battery in which a plurality of cells of lithium-ion secondary batters is connected in series, variations in self-discharge performances and side reaction amounts in charging occurs among cells due to, for example, repeated charging and discharging, being left for a long period of time, or application of a constant voltage, and resulting in occurrence of differences in charge statuses between the cells. When charging and discharging are continued under a condition of such differences in the charge statuses, a cell having a high charge status charged to a relatively high voltage, and deterioration of the battery or a decrease in safety may be caused.

To cope with this, an assembled battery in which a plurality of cells of lithium-ion secondary batteries is connected in series has been used with an external circuit to equalize the charge statuses. For example, PTL 1 discloses a technique in which a switch for connecting a voltage correction capacitor for each cell and a switch for connecting the voltage correction capacitors in parallel are provided, and a connection destination of the voltage correction capacitor is switched according to a voltage of the cell.

PTL 2 discloses a technique for detecting a charge status of each of all electric cells connected in series in each of a plurality of battery blocks. In this technique, when the charge status of any one of the cells is equal to or greater than a predetermined value, a current applied to the equipped cooling device is stopped, and then a constant current is applied to the battery block for a predetermined period to perform equalizing charge.

PTL 3 discloses a technique including discharge resistors in an assembled battery in which a plurality of secondary batteries is connected in series. In the technique, the discharge resistors have the same resistance, and one end of each discharge resistor is connected to the positive electrode of a corresponding secondary battery and the other end is connected to the negative electrode of the corresponding secondary battery. In this technique, a current sensor for detecting a level of charging current and a discharge switch for each secondary battery are provided, and the secondary batteries are equalized all at once by turning on the switch when the charging current is in a section between two threshold values.

### CITATION LIST

### Patent Literature

### [PTL 1]

Japanese Unexamined Patent Application Publication No. 2006-109620

### [PTL 2]

Japanese Unexamined Patent Application Publication No. 2007-195272

### [PTL 3]

Japanese Unexamined Patent Application Publication No. 2009-159768

### SUMMARY OF INVENTION

### Technical Problem

An external circuit for equalizing charge statuses often includes expensive electronic elements, and requires a complicated control technique, and a cost of an assembled battery using lithium-ion secondary battery is high.

### Solution to Problem

According to an aspect of the present disclosure, a power storage system includes a first cell group including a plurality of first cells connected in series. Each of the plurality of first cells is a non-aqueous secondary battery. The power storage system includes a second cell group including a plurality of second cells connected in series. Each of the plurality of second cells is an aqueous secondary battery. One or more cells of the plurality of second cells included in the second cell group are connected in parallel to a corresponding one of the plurality of first cells included in the first cell group.

According to an aspect of the present disclosure, a power supply includes a power storage system including a first cell group including a plurality of first cells connected in series. Each of the plurality of first cells is a non-aqueous secondary battery. The power storage system includes a second cell group including a plurality of second cells connected in series. Each of the plurality of second cells is an aqueous secondary battery. One or more cells of the plurality of second cells included in the second cell group are connected in parallel to a corresponding one of the plurality of first cells included in the first cell group.

According to an aspect of the present disclosure, a driving device includes a power supply including a power storage system. The power storage system includes a first cell group including a plurality of first cells connected in series. Each of the plurality of first cells is a non-aqueous secondary battery. The power storage system includes a second cell group including a plurality of second cells connected in series. Each of the plurality of second cells is an aqueous secondary battery. One or more cells of the plurality of second cells included in the second cell group are connected in parallel to a corresponding one of the plurality of first cells included in the first cell group.

According to an aspect of the present disclosure, a power control device includes a power supply including a power storage system. The power storage system includes a first cell group including a plurality of first cells connected in series. Each of the plurality of first cells is a non-aqueous secondary battery. The power storage system includes a second cell group including a plurality of second cells connected in series. Each of the plurality of second cells is an aqueous secondary battery. One or more cells of the plurality of second cells included in the second cell group are connected in parallel to a corresponding one of the plurality of first cells included in the first cell group.

According to an aspect of the present disclosure, a method for equalizing power storage statuses includes connecting a plurality of first cells in series to form a first cell group. Each of the plurality of first cells is a non-aqueous secondary battery. The method includes connecting a plurality of second cells in series to form a second cell group. Each of the plurality of second cells is an aqueous secondary battery. The method includes connecting one or more cells of the plurality of second cells of the second cell group in parallel to each of the plurality of first cells of the first cell group.

### Advantageous Effects of Invention

According to an embodiment of the disclosure, a power storage system that safely and inexpensively equalizes charge statuses in a cell group using a nonaqueous secondary battery such as a lithium-ion secondary battery is provided.

According to an embodiment of the present disclosure, equalization of charge statuses in a cell group is performed safely and at low cost using a nonaqueous secondary battery such as a lithium-ion secondary battery.

### BRIEF DESCRIPTION OF DRAWINGS

The accompanying drawings are intended to depict example embodiments of the present invention and should not be interpreted to limit the scope thereof. The accompanying drawings are not to be considered as drawn to scale unless explicitly noted. Also, identical or similar reference numerals designate identical or similar components throughout the several views.

FIG. 1 is a schematic diagram illustrating a power storage system in which a sealed aqueous secondary battery is connected to a lithium-ion secondary battery according to an embodiment of the disclosure.

FIG. 2 is a schematic diagram illustrating an assembled battery including six single cells of lithium-ion secondary batteries according to a related art.

FIG. 3 is a diagram illustrating an assembled battery including three single cells of lithium-ion secondary batteries according to a related art.

FIG. 4 is a diagram illustrating a cell group including three single cells that are lithium-ion secondary batteries using the power storage system according to an embodiment of the disclosure.

FIG. 5 is a conceptual diagram illustrating a model of the power storage system according to an embodiment of the disclosure.

FIG. 6 is a schematic diagram illustrating a power storage system in which twelve single cells of sealed aqueous secondary batteries are connected to six single cells of a lithium-ion secondary batteries according to an embodiment of the disclosure.

FIG. 7 is a graph illustrating a relationship between a charging time and a voltage of a power storage system in which twelve single cells of sealed aqueous secondary batteries are connected to six single cells of a lithium-ion secondary batteries according to an embodiment of the disclosure.

FIG. 8 is a graph illustrating a relationship between a charging time and a voltage of an assembled battery including six single cells of lithium-ion secondary batteries according to a related art.

### DESCRIPTION OF EMBODIMENTS

The terminology used herein is for the purpose of describing particular embodiments only and is not intended to be limiting of the present invention. As used herein, the singular forms “a,” “an,” and “the” are intended to include the plural forms as well, unless the context clearly indicates otherwise.

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

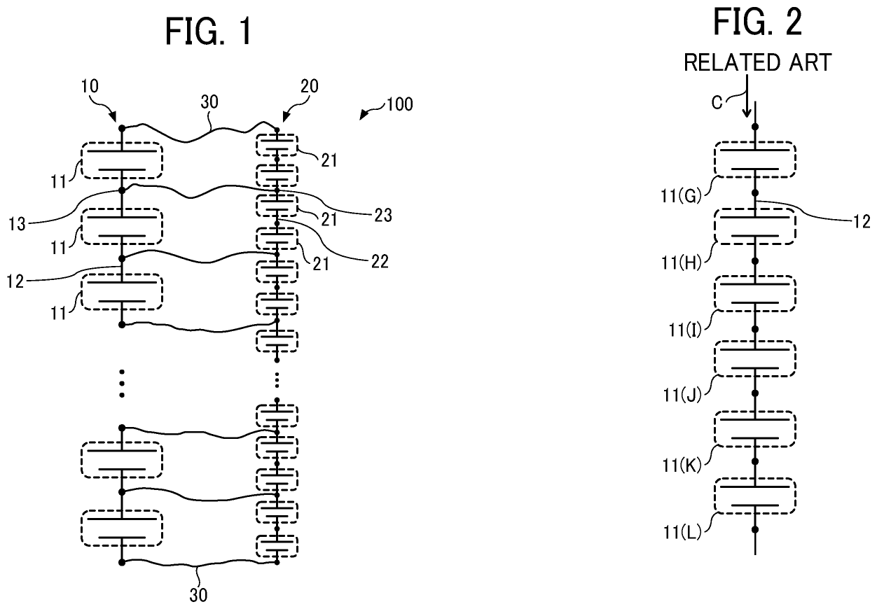

Embodiments of the present disclosure are described below. FIG. 1 is a schematic diagram of a power storage system in which sealed aqueous secondary batteries are connected to lithium-ion secondary batteries according to an embodiment of the present disclosure.

A power storage system 100 according to the present embodiment includes a first cell group 10 and a second cell group 20.

The first cell group 10 includes a plurality of first cells 11 that is a plurality of non-aqueous secondary batteries. The plurality of first cells 11 is connected with one another in series. In the present embodiment, each first cell 11 of non-aqueous secondary battery is connected with an adjacent first cell 11 by a lead 12 in series (see FIG. 1).

In the description of embodiments, the non-aqueous secondary battery refers to a non-aqueous electrolyte battery that uses an ion conductive electrolytic solution for an aprotic organic solvent as an electrolytic solution. In the present embodiment, as an example of non-aqueous secondary battery, a lithium-ion secondary battery using an electrolytic solution obtained by dissolving a lithium salt in an aprotic organic solvent is described.

In the lithium-ion secondary battery, a carbon material that absorbs and desorbs lithium-ions is used as a negative electrode active material, and lithium-containing metallic oxides such as LiCoO₂, LiNiO2, LiMn₂O₄, and LiFeO₂ are used as a positive electrode active material.

Because using the electrolytic solution of aprotic organic solvent, the lithium-ion secondary battery having such a configuration described above without restriction due to electrolysis of water, has a high battery voltage equal to or greater than 3V so as to be a storage battery having a large energy density per weight, compared with a secondary battery that uses aqueous electrolytic solution, such as a nickel-cadmium battery and a nickel hydrogen battery that are subjected to restriction of electrolysis of water of approximately 1.2 V.

In the present embodiment, a type of lithium-ion secondary battery is not limited, but a lithium-ion secondary battery having the positive electrode including a positive electrode active material including lithium transition metal oxides containing manganese and the negative electrode containing carbon material is preferably used. In the lithium-ion secondary battery, lithium-ions are desorbed and occluded at the positive electrode, and lithium-ions are intercalated and desorbed at the negative electrode, and charging and discharging are performed, accordingly.

The second cell group 20 includes a plurality of second cells 21 that is a plurality of aqueous secondary batteries. The plurality of second cells 21 is connected with one another in series. In the present embodiment, each second cell 21 of aqueous secondary battery is connected with an adjacent second cell 21 by a lead 22 in series (see FIG. 1).

In the description of embodiments, an aqueous secondary battery (also referred to as an aqueous solution secondary battery) is a secondary battery using an electrolytic solution that is an aqueous solution. In the present embodiment, as an example of aqueous secondary battery, a sealed aqueous secondary battery in which an electrolytic solution that is an aqueous solution is sealed in a battery case is described.

In the aqueous secondary battery (scaled aqueous secondary battery), as charging proceeds, water is oxidized to generate oxygen gas from the positive electrode, and the oxygen gas moves to the negative electrode to oxidize the negative electrode while generating water.

The restriction due to the electrolysis of water as described above allows the aqueous secondary battery (scaled aqueous secondary battery) to maintain a charge status without deteriorating the battery even when the battery is charged more than a storage amount. Such a charging mechanism of the sealed aqueous secondary battery is known as “oxygen recombination reaction,” “cathodic absorption,” or “Neumann effect.”

A type of aqueous secondary battery (scaled aqueous secondary battery) is not limited, and for example, an alkaline secondary battery using an alkaline electrolyte such as a nickel hydrogen battery, a nickel-cadmium battery, or a nickel-zinc battery, or a sealed lead-acid battery using sulfuric acid as an electrolyte such as a valve-regulated lead-acid battery may be used. A single type of sealed aqueous secondary battery may be used alone, or two or more types of sealed aqueous secondary battery may be used in combination. The nickel zinc battery is preferably used because the market price of zinc is inexpensive.

In the nickel-zinc batteries (also referred to as nickel-zinc secondary batteries), oxidation-reduction of nickel hydroxide and nickel oxyhydroxide occurs in a range of 0.2 V (vs. NHE) to 0.5 V (vs. NHE) at the positive electrode with respect to normal hydrogen electrode and oxidation-reduction of zinc oxide and zinc occurs in a range of −1.6 V (vs. NHE) to −1.0 V (vs. NHE) at the negative electrode with respect to normal hydrogen electrode, and charging and discharging are performed, accordingly.

The nickel-zinc secondary batteries are one of the Edison batteries. In the nickel-zinc secondary batteries, oxygen can be produced from the positive electrode at a voltage equal to or greater than at least 1.8 V per cell because of the high hydrogen overvoltage of zinc that is used for the negative electrode. In addition, in the nickel-zinc secondary battery, at a voltage of at least 1.8 V per cell, oxygen generated from the positive electrode moves to the negative electrode and oxidizes the negative electrode to generate water.

In the power storage system 100 of the present embodiment, one or more cells (two second cells 21, 21 in the present embodiment) of the second cell group 20 are connected in parallel to each first cell 11 of the first cell group 10.

Specifically, as illustrated in FIG. 1, each of a plurality of leads 30 is connected to a corresponding one of nodes 13 of the lead 12, and each node 13 is between first cells 11 of lithium-ion secondary batteries included in the first cell group 10.

Each lead 30 is further connected to a corresponding one of a plurality of nodes 23 of the lead 22. Each node 23 is provided for every two second cells 21, 21 of sealed aqueous secondary batteries included in the second cell group 20.

In the present embodiment, each two second cells 21 of the second cell group 20 are connected in parallel to a single first cell 11 of the first cell group 10, but the number of second cells 21 of the second cell group 20 connected in parallel to each first cell 11 of the first cell group 10 is not limited to two. In other words, the number of second cells 21 of the second cell group 20 connected in parallel to each first cell 11 of the first cell group 10 may be one, or three or more.

The power storage system 100 according to the present embodiment uses, as the lithium-ion secondary battery included in the first cell group 10, a lithium-ion secondary battery that has the positive electrode using a positive electrode active material including lithium transition metal oxides containing manganese and the negative electrode containing carbon material. In addition, a nickel-zinc secondary battery is used as the sealed aqueous secondary battery included in the second cell group 20.

In other words, in the power storage system 100 according to the present embodiment, two second cells 21, 21, which are nickel-zinc batteries, are connected in parallel to a single first cell 11, which is a lithium-ion secondary battery.

In the power storage system 100 of the present embodiment, it is preferable that a charge voltage of one or more second cells 21 of the second cell group 20 is equal to or less than a charge voltage of each first cell 11 of the first cell group 10.

In the present embodiment, in case that the lithium transition metal oxide contained in the positive electrode active material of the lithium-ion secondary batteries included in the first cell group 10 is LiₓMO₂ (Li: lithium, M: transition metal, O: oxygen), when a stoichiometric composition x=0.5, a voltage of a single first cell 11 is y V.

In addition, among the nickel-zinc secondary batteries included in the second cell group 20, a total voltage of each two second cells 21, which are nickel-zinc secondary batteries, connected with each other in series and connected in parallel to the corresponding first cell 11, which is the lithium-ion secondary battery, is z V.

It is preferable to select the lithium-ion secondary battery and the nickel-zinc secondary battery in a manner that the voltage of the single first cell of the lithium-ion secondary battery and the total voltage of the two second cells of the nickel-zinc secondary batteries satisfies y≥Z.

Further, the lithium-ion secondary battery is preferably selected such that when one cell of the lithium-ion secondary battery is charged to 3.8 V, the stoichiometric composition of the positive electrode active material Li_{y}MO₂ of the lithium-ion secondary battery satisfies at least y<0.5.

In addition, in the present embodiment, when nickel-zinc batteries are used as the sealed aqueous secondary batteries, it is preferable that the total charge power amount (also referred to as a total storage power amount or total charge electric power amount) of the nickel-zinc batteries is 0.5 times or more of the total charge power amount of power storage system 100. In other words, in the present embodiment, it is preferable that a ratio of the total charge power amount of the nickel-zinc batteries to the total charge power amount of the power storage system 100 is 0.5 or more.

The total charge power amount of the nickel-zinc batteries indicates a rated total storage power amount of the nickel-zinc batteries in case that two cells that are nickel-zinc secondary batteries are connected in parallel to a single cell that is a lithium-ion secondary battery. A charge power amount (charge electric power amount) of a power storage system indicates the maximum power (maximum electric power) to be input to the power storage system in case that two cells that are nickel-zinc secondary batteries are connected in parallel to a single cell that is a lithium-ion secondary battery.

In the power storage system 100 according to the present embodiment described above, one or more cells (for example, two second cells 21, 21) of the second cell group 20 are connected in parallel to each first cell 11 of the first cell group 10. With such a configuration, the non-aqueous secondary battery (lithium-ion secondary battery) included in the first cell group 10 is subjected to the restriction (or be controlled) due to the electrolysis of water by the aqueous secondary battery (scaled aqueous secondary battery) included in the second cell group 20.

Accordingly, a voltage of each first cell 11 of lithium-ion secondary battery is equal to or less than a total voltage of one or more cells (for example, two second cells 21, 21) of aqueous secondary batteries (scaled aqueous secondary battery).

Due to this, according to the power storage system 100 of the present embodiment, differences in the charge statuses among the cells of the non-aqueous secondary batteries (lithium-ion secondary batteries) is reduced, and the differences in the charge statuses among the cells are equalized (or taken balance).

In a case of an assembled battery (cell group) in which a plurality of cells of non-aqueous secondary batteries (lithium-ion secondary batteries) is simply connected in series, differences in the charge statuses of the cell occurs when the battery is used for a long period of time, due to variations in the power storage amounts and variations in self-discharge performances, among the cells (see FIG. 2).

Even in a case that an assembled battery (cell group) in which a plurality of cells of non-aqueous secondary batteries (lithium-ion secondary batteries) that does not have the variations described above or variations in the internal resistance among the cells are connected in series is obtained, when a current is applied to the assembled battery, the internal resistance and Joule heat, which is proportional to the product of the square of the passed current, are generated in each of all the cells.

At this time, since a particular cell is affected by heat generated in the peripheral cells, a difference in temperature between the cells occurs. The self-discharge of the non-aqueous secondary battery (lithium-ion secondary battery) depends on the temperature, and the self-discharge becomes larger as the temperature is higher. Accordingly, after all, when the battery is used for a long period of time, the differences in the charge statuses of the cell occur.

When an assembled battery (cell group) of a plurality of cells of non-aqueous secondary batteries (lithium-ion secondary batteries) connected in series, is charged while having the differences in the charge statuses of the cells, a cell having a charge status higher than the other cells is more exposed to overcharge. For example, when a lithium-ion secondary battery as a non-aqueous secondary battery is overcharged to an unnecessarily high charge status, excessive extraction of lithium-ions from the positive electrode occurs, and excessive insertion of lithium-ions occurs at the negative electrode, resulting in deposition of lithium metal.

As a result, in the positive electrode from which lithium-ions have been lost, in addition to an extremely unstable high oxide being generated, the voltage continues to rise due to overcharging, and organic substances and the like in the electrolyte undergo a decomposition reaction to generate a large amount of flammable gas, thereby deteriorating the battery performance. Alternatively, a rapid exothermic reaction occurs to cause abnormal heat generation in the battery, and this may eventually cause ignition, so that the safety of the battery is not sufficiently ensured.

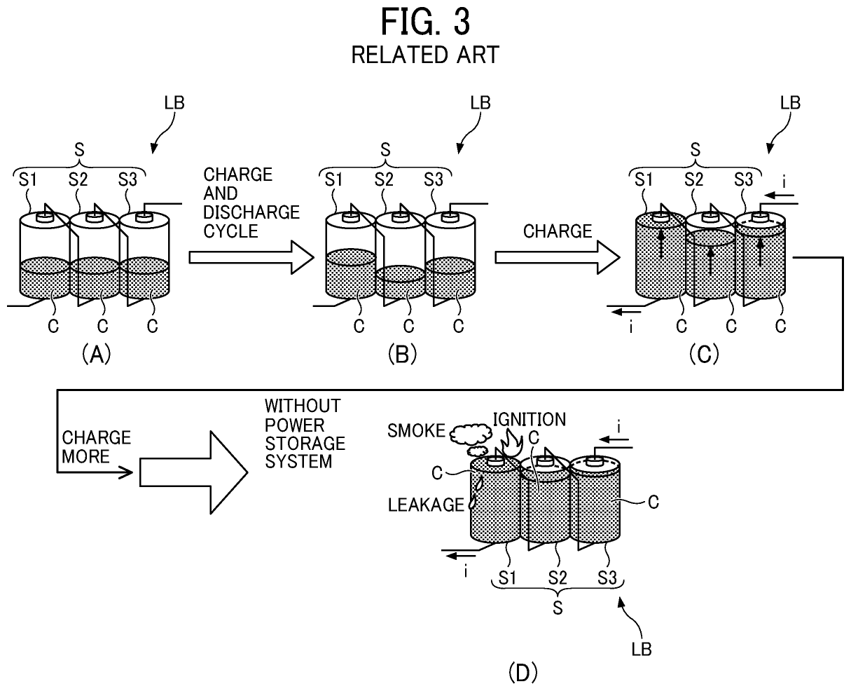

FIG. 3 is a diagram illustrating an assembled battery composed of three single cells that are non-aqueous secondary batteries (lithium-ion secondary batteries). As illustrated in (A) of FIG. 3, when a charge-discharge cycle is repeated in the assembled battery (cell group) LB in which three cells S (cells S1 to S3) having the same charge statuses C of lithium-ion secondary batteries are connected in series, the charge statuses C of the cells S varies as illustrated in FIG. 3b.

When the assembled battery LB of the secondary batteries is charged in this state, as illustrated in (C) of FIG. 3, when the charge status C of the cell S1 that is a part of the battery is full (fully charged), each of the charge statuses C of the other cells S2 and S3 is not fully charged. When the charging is further continued with the differences in the charge statuses C of the cells S1 to S3, as illustrated in (D) of FIG. 3, when the charge statuses of the other cells S2 and S3 become fully charged, the charge status C of the cell S1 that has been fully charged becomes overcharged.

As described above, in the assembled battery LB of the lithium-ion secondary batteries whiteout using the power storage system of the present embodiment, as illustrated in (D) of FIG. 3, the cell S (cell S1) having the charge status C that is high is overcharged, and liquid leakage, smoking, or ignition may occur.

On the other hand, in a case of using an aqueous secondary battery (scaled aqueous secondary battery) such as a nickel-zinc battery, a phenomenon in which oxygen generated in the positive electrode at a time of overcharge moves to the negative electrode and oxidizes the negative electrode to return to water occurs, and a gas absorption mechanism, which is referred to as a “Neumann effect” described above, is used in the cathode.

As a result, the aqueous secondary battery (scaled aqueous secondary battery) maintains a charge status without causing an increase in the internal pressure of the battery, an increase in voltage, and an increase in the concentration of the electrolytic solution even when charging is continued from the outside to an amount greater than or equal to the storage power amount of the battery. Accordingly, in an assembled battery (cell group) of a plurality of cells of aqueous secondary batteries (scaled aqueous secondary batteries) connected in series, all cells can be fully charged by continuing charging even when the differences in the charge statuses of the cells occurs, and this is excellent in safety.

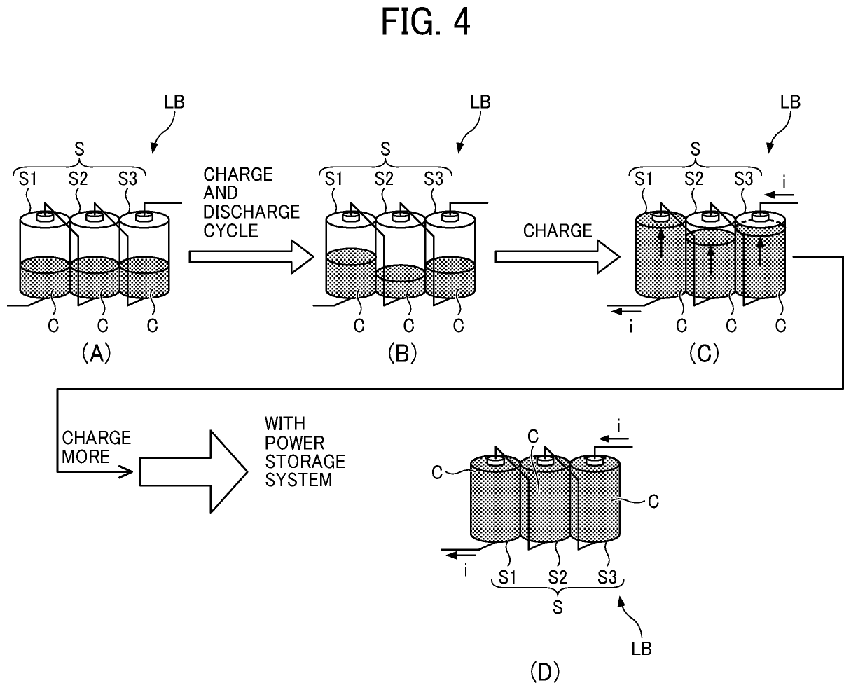

FIG. 4 is a diagram illustrating a cell group including three single cells that are lithium-ion secondary batteries using the power storage system of the present embodiment. In FIG. 4, identical reference numerals are assigned to components that are identical to the components or parts illustrated in FIG. 3, and a description of the identical components is omitted. In each of cell groups LB of (A) to (C) of FIG. 4, similarly to the assembled battery LB of the lithium-ion secondary batteries illustrated in FIG. 3, when charging is performed after repeating of the charge-discharge cycle, the cells S2 and S3 are not fully charged at a time at which the cell S1 becomes to be fully charged.

In the cell group LB of the lithium-ion secondary batteries illustrated in FIG. 4, by using the power storage system of the present embodiment, even when charging is continued in a state in which the charge status C of the cells S1, which is a part of the battery, is fully charged, the fully charged cells S1 is subjected to the restriction due to the electrolysis of water by the aqueous secondary batteries connected in parallel. Accordingly, as illustrated in (D) of FIG. 4, when the charging continues, the charge status C of the cell S1 is maintained as being fully charged, and the charge statuses C of the other cells S2 and S3 turns to be also fully charged.

As described above, in the cell group LB of the lithium-ion secondary batteries using the power storage system of the present embodiment, even when charging is continued while the differences in the charge status of cells occurring, the cell S (cell S1) having a high charge status C is not overcharged, and the charge statuses of the cells are equalized after the charging. Accordingly, in the cell group LB of the lithium-ion secondary batteries using the power storage system of the present embodiment, liquid leakage, smoking, or ignition is prevented (see FIG. 4).

In the present embodiment, such properties of an aqueous secondary battery (scaled aqueous secondary battery) are applied to assembled battery (cell group) of a non-aqueous secondary battery (lithium-ion secondary battery). According to the present embodiment, differences in charge statuses occurred between cells of an assembled battery (cell group) in which a plurality of cells of non-aqueous secondary batteries (lithium-ion secondary batteries) is connected in series equalized safely and inexpensively.

In the power storage system 100 according to the present embodiment described above, the charge voltage of one or more second cells 21 of the second cell group 20 is equal to or lower than the charge voltage of each first cell 11 of the first cell group 10. Accordingly, a charge voltage of each first cell 11 of lithium-ion secondary battery is controlled to be equal to or less than a total charge voltage of one or more cells (for example, two second cells 21, 21) of aqueous secondary batteries (scaled aqueous secondary batteries). Accordingly, the differences in the charge statuses of the cells of lithium-ion secondary batteries are significantly reduced.

In the power storage system 100 according to the present embodiment described above, a lithium-ion secondary battery is used as a non-aqueous secondary battery. Lithium-ion secondary batteries are widely used as non-aqueous secondary batteries. Accordingly, even in such an assembled battery (cell group) configured by the lithium-ion secondary batteries, the differences in the charge statuses of the cells are reduced, resulting in enhancing the versatility of the power storage system 100.

The power storage system 100 according to the present embodiment described above uses, as the lithium-ion secondary battery included in the first cell group 10, a lithium-ion secondary battery that has the positive electrode including a positive electrode active material including lithium transition metal oxide containing manganese and the negative electrode containing carbon material. With the configuration described above, an assembled battery (cell group) of a plurality of cells of lithium-ion secondary batteries connected in series is with a large capacity and high output at low cost.

In the power storage system 100 according to the present embodiment described above, the sealed aqueous secondary batteries are used as the non-aqueous secondary batteries included in the second cell group 20. In the sealed secondary battery, since the inside of the battery in which the electrolytic solution is accommodated is sealed, electrolysis of water in the battery is efficiently performed. Accordingly, in the present embodiment, by using the sealed aqueous secondary battery, the differences in the charge statuses of the cells are equalized with high accuracy.

In the power storage system 100 according to the present embodiment described above, the nickel-zinc secondary batteries are used as the sealed aqueous secondary batteries. The nickel-zinc secondary battery is obtainable with a low cost among the types of sealed aqueous secondary batteries because the market price of zinc is low. Accordingly, an application of the sealed aqueous secondary batteries to an assembled battery (cell group) of a plurality of cells of lithium-ion secondary batteries connected in series achieves equalization of the charge statuses at low cost.

In the power storage system 100 of the present embodiment described above use lithium-ion secondary batteries the non-aqueous secondary batteries included in the first cell group 10, and nickel zinc batteries are used as the aqueous secondary batteries (scaled aqueous secondary batteries) included in the second cell group 20. In this case, two second cells 21 of nickel-zinc batteries connected in series are connected in parallel for each first cell 11 of lithium-ion secondary battery.

In the nickel-zinc cell, because of the high hydrogen overvoltage of zinc that is used for the negative electrode, a voltage at which oxygen recombination occurs is around 2 V, and in the battery in which two cells are connected in series, the voltage is around 4 V.

In case that a lithium-ion secondary battery that has the positive electrode including a positive electrode active material including lithium transition metal oxides containing manganese is use, as the lithium-ion secondary battery included in the first cell group 10, the upper limit voltage of each cell of the lithium-ion secondary battery is around 4 V. Accordingly, the charge voltage of the battery in which two nickel-zinc cells are connected in series is close to the upper limit voltage of a single cell of the lithium-ion secondary battery.

Accordingly, in such a power storage system in which a plurality of lithium-ion secondary batteries is connected in series in a manner that a series battery including two nickel-zinc batteries is connected in parallel to a single lithium-ion secondary battery, the nickel-zinc secondary battery performs a function of equalizing the charge statuses. As a result, as a sealed aqueous secondary battery having a charge voltage corresponding to the maximum voltage of a lithium-ion secondary battery, the nickel-zinc secondary battery is replaceable with a conventional one used for an external circuit for equalizing the charge statuses, at low cost without any difficulty.

In the present embodiment, two cells of nickel-zinc secondary batteries of which a voltage at which oxygen recombination occurs is in the vicinity of 2 V is used corresponding to the upper limit voltage of around 4 V of each cell of lithium-ion secondary battery. However, the aqueous secondary battery (scaled aqueous secondary battery) is not limited to the two cells of nickel-zinc secondary batteries.

For example, when the upper limit voltage of each cell of the lithium-ion secondary battery is in the vicinity of 3.5 V, a single cell of nickel hydrogen battery or nickel-cadmium battery in which a voltage causing oxygen recombination is in the vicinity of 1.5 V is connected in series to a single cell of a nickel-zinc battery.

In the power storage system 100 according to the present embodiment described above, when the nickel-zinc battery is used as the sealed aqueous secondary battery, a total charge power amount of the nickel-zinc battery is adjusted to 0.5 times or more of a total charge power amount of the power storage system 100.

Accordingly, the power storage system 100 according to the present embodiment increases the number of charge-discharge cycles performed until the storage power amount reaches 90% of an initial amount in an assembled battery (cell group) in which a plurality of cells of lithium-ion secondary batteries is connected in series. Further, in the power storage system 100 according to the present embodiment, the maximum cell voltage difference after charge-discharge cycles is reduced.

In other words, in the power storage system 100 according to the present embodiment, by setting a total charge power amount of the nickel-zinc battery to 0.5 times or more of the charge power amount of the power storage system 100, the charge statuses of the cells of lithium-ion secondary batteries are kept being equalized. In addition, in the power storage system 100 according to the present embodiment, power storage performance in a long-term of charge-discharge cycles while the charge statuses of the cells of lithium-ion secondary batteries are kept being equalized.

The power storage system 100 according to the present embodiment can be used for various power supplies by utilizing the above-described effects. In other words, by configuring a power supply including the power storage system 100 according to the present embodiment, the power source includes a power storage system in which one or more cells of aqueous secondary batteries (sealed aqueous secondary batteries) such as a nickel-zinc batteries are connected in parallel to a single cell of non-aqueous secondary battery (lithium-ion secondary battery).

In substantially the same manner as to the case with the power storage system described above, in such a power supply including such a power storage system, differences in charge statuses occurred between cells of an assembled battery (cell group) in which a plurality of cells of non-aqueous secondary batteries (lithium-ion secondary batteries) is connected in series equalized safely and inexpensively.

The power supplies including the power storage system 100 according to the present embodiment can be used for various applications. Examples of such applications include driving devices, lifting devices, and power (electric power) control devices.

Examples of the driving devices include, but not particularly limited, vehicles such as hybrid vehicles and electric vehicles and lifting devices such as elevator devices.

In the case of a vehicle, for example, the power supply including the power storage system 100 according to the present embodiment is mounted on a hybrid electric vehicle driven by an internal combustion engine and a motor. The mounted power supply can function as a power supply for starting engine, restarting engine after idling stop, supplying power in acceleration, and supplying power for power regeneration by braking, in the hybrid electric vehicles. Note that the hybrid electric vehicle is an example of a driving device including the power supply according to the present embodiment.

In the case of a lifting device, for example, a power supply including the power storage system 100 according to the present embodiment is mounted on an elevator device. The mounted power supply can be mounted in an elevator system as a power supply for mitigating power fluctuations when energy consumption and energy generation are interchanged due to vertical motion and weight on board. The elevator device is another example of the driving device including the power supply according to the present embodiment.

In the case of a power control device, for example, a power supply including the power storage system 100 according to the present embodiment is mounted on a power balance adjustment device, for example. In the power balance adjustment device, the mounted power supply can function as a power supply for reducing fluctuations in system power. In addition, the mounted power supply can function as a power supply for reducing fluctuations in power generation and power consumption in relation to power generated by renewable energy such as solar power generation or wind power generation. The power balance adjustment device is an example of a power control device including the power supply according to the present embodiment.

In a method of equalizing power storage statuses according to the present embodiment, a plurality of cells (first cells) of nonaqueous secondary batteries is connected in series to form a first cell group, a plurality of cells (second cells) of aqueous secondary batteries is connected in series to form a second cell group, and one or more cells (second cells) of the second cell group are connected in parallel to each cell (first cell) of the first cell group. Specifically, the method of equalizing power storage statuses according to the present embodiment is implementable by the above-described power storage system.

In the method of equalizing power storage statuses according to the present embodiment, for example, a lithium-ion secondary battery is used as the non-aqueous secondary battery, and a plurality of first cells 11 of lithium-ion secondary batteries is connected in series to be included in the first cell group 10. Each first cells 11 of lithium-ion secondary batteries is connected in series with an adjacent first cell 11 by the lead 12 (see FIG. 1).

Next, a sealed aqueous secondary battery (for example, a nickel-zinc secondary battery) is used as a cell of aqueous secondary battery, and the plurality of second cells 21 of sealed aqueous secondary batteries is connected in series to be included in the second cell group 20. Each second cell 21 of nickel-zinc secondary battery is connected in series with an adjacent second cell 21 by the lead 22 (see FIG. 1).

Next, one or more cells (two second cells 21, 21) of the second cell group 20 are connected in parallel to each first cell 11 of the first cell group 10. Specifically, each of a plurality of leads 30 is connected to a corresponding one of the nodes 13 of the lead 12, and each node 13 is between first cells 11 of lithium-ion secondary batteries included in the first cell group 10. The lead 30 is further connected to a corresponding one of the nodes 23 of the lead 22. Each node 23 is provided for every two second cells 21, 21 of sealed aqueous secondary batteries included in the second cell group 20 (see FIG. 1).

In the present embodiment, each two second cells 21 of the second cell group 20 are connected in parallel to a single first cell 11 of the first cell group 10, but the number of second cells 21 of the second cell group 20 connected in parallel to each first cell 11 of the first cell group 10 is not limited to two. In other words, the number of second cells 21 of the second cell group 20 connected in parallel to each first cell 11 of the first cell group 10 may be one, or three or more.

In the method of equalizing power storage statuses according to the present embodiment described above, a plurality of cells (first cells) of nonaqueous secondary batteries is connected in series to form a first cell group, a plurality of cells (second cells) of aqueous secondary batteries is connected in series to form a second cell group, and one or more cells (second cells) of the second cell group are connected in parallel to each cell (first cell) of the first cell group. Accordingly, an effect that is substantially the same as the effect obtained by the power storage system described above is obtained by the method of equalizing power storage statuses according to the present embodiment according to the present embodiment.

Specifically, according to the method of equalizing power storage statuses according to the present embodiment, by applying the properties of an aqueous secondary battery to an assembled battery (cell group) of non-aqueous secondary batteries, differences in charge statuses occurred between the cells of the assembled battery (cell group) in which a plurality of cells of non-aqueous secondary batteries is connected in series are equalized safely and inexpensively.

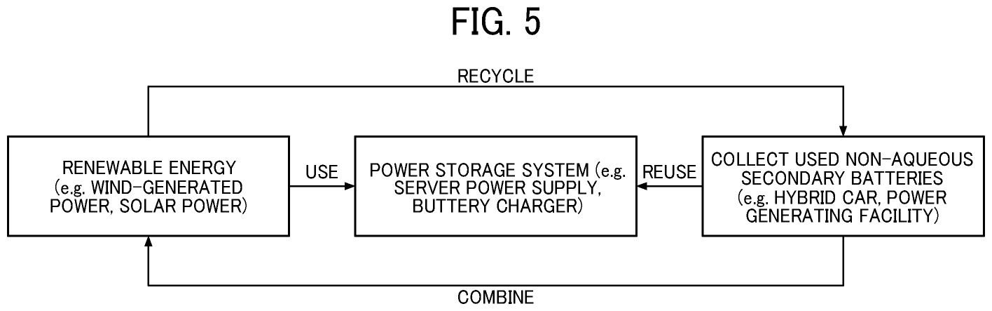

FIG. 5 is a conceptual diagram illustrating a model of the power storage system according to the present embodiment. Charge statuses of non-aqueous secondary batteries such as lithium-ion secondary batteries used in such as hybrid vehicles or power generation facilities are naturally different after use of the butteries due to difference in use environment and use time. Due to this, an assembled battery has substantially failed to include such used non-aqueous secondary batteries by combining according to a related art.

In contrast to this, in the power storage system according to the present embodiment described above, even if charging is continued with differences in the charge statuses of the cells, the charge statuses of the cells are equalized after charging, and a used nonaqueous secondary battery is also usable, accordingly. Specifically, used lithium-ion secondary batteries used in, for example, a hybrid vehicle or a power generation facility are collected, a plurality of the batteries is connected in series to form an assembled battery (cell group), and the power storage system according to the present embodiment is applied to the assembled battery to implement a server power supply, for example.

As a result, even if the obtained power storage system such as a server power supply or a buttery charger includes such a used non-aqueous secondary battery, because of the restriction of electrolysis of water caused by the aqueous secondary batteries connected in parallel, the charge statuses of the cells after charging are equalized. Accordingly, as illustrated in a part on the right of FIG. 5, the used non-aqueous secondary battery is usable by using the power storage system according to the present embodiment.

In addition, as illustrated in a part on the left of FIG. 5, even when the power storage system including the used nonaqueous secondary battery is used as a server power supply of renewable energy such as solar power generation or wind power generation or a buttery charger of generated power, the charge statuses of the cells after charging are equalized. Accordingly, the power storage system according to the present embodiment is usable for renewable energy power generation.

Further, as illustrated in an upper part of FIG. 5, a non-aqueous secondary battery that has been used in a server power supply of renewable energy or a buttery charger is applicable to the power storage system according to the present embodiment as a used non-aqueous secondary battery. Accordingly, the power storage system according to the present embodiment can develop a decarbonization society or a circulation-type society through renewable energy power generation and contribute to achieving carbon-neutral and sustainable development goals (SDGs).

### EXAMPLES

Further understanding can be obtained by reference to certain specific examples provided below for the purpose of illustration only and are not intended to be limiting. Various tests and evaluations are performed in accordance with the following methods.

### Example 1 and Comparative Example 1

### Example 1

Lithium-ion secondary batteries which are cells mounted in a used battery pack (assembled battery) (ASSY 1D100 5P6 J03 manufactured by Honda Co., Ltd.) were collected. Each of the collected cells was sufficiently left in a room-temperature environment, and then subjected to constant current discharge at a current of 1000 mA corresponding to a rated 5-hour rate using a charge and discharge tester (charge/discharge system HJB0630SD8 manufactured by HOKUTO DENKO COOPERATION) until the voltage reached 2.5 V.

After that, each buttery (cell) was charged with a constant current of 1000 mA until the voltage reached 4.2 V, and charged with a constant voltage of 4.2 V for 30 minutes to be fully charged. After the battery (cell) was left in a fully-charged state for 1 hour, the battery was discharged at a constant current of 1000 mA until the voltage reached 1.0 V. In doing so, an amount of electricity and an electric power amount consumed from a time of starting of discharging to a time at which the voltage reached 2.5 V was taken as a power storage capacity of the cell.

Six cells of lithium-ion secondary batteries each having an electric power amount of 18 Wh as a power storage capacity were selected and connected in series by using 8.0 mmφ-based vinyl electric wires (an assembled buttery of the six lithium-ion secondary batteries connected in series).

A nickel-zinc buttery (manufactured by Shenzhen Melasta Battery Co., Ltd., 2600 mWh) was sufficiently left in a room-temperature environment, and was then subjected to constant current discharge using a charge-discharge tester at a current 320 mA corresponding to a rated 5-hour rate until the voltage reached 1.0 V. After that, the battery was charged with a constant current of 320 mA for 7.5 hours to be fully charged.

After the battery (cell) was left in a fully-charged state for 1 hour, the battery was discharged at a constant current of 320 mA until the voltage reached 1.0 V. In doing so, an amount of electricity and an electric power amount consumed from a time of starting of discharging to a time at which the voltage reached 1.0 V was taken as a power storage capacity of the cell.

Twelve cells of nickel-zinc batteries each having an electric power amount of 2500 mWh as a power storage capacity were selected.

Each of the selected cells was serially connected one another using a nickel ribbon wire having a width of 4.0 mm and a thickness of 0.1 mm. More specifically, one end of the nickel ribbon wire is connected to the positive terminal of one cell of nickel-zinc battery cell and the other end is connected to the negative terminal of another cell of nickel-zinc battery by resistance welding (an assembled buttery of twelve nickel-zinc battery cells connected in series).

Each cell of the lithium-ion secondary batteries connected in series was separately charged with a constant current of 1000 mA to have 3.0 V, and each cell of the nickel-zinc batteries connected in series was separately charged with constant current of 320 mA to have 1.5 V.

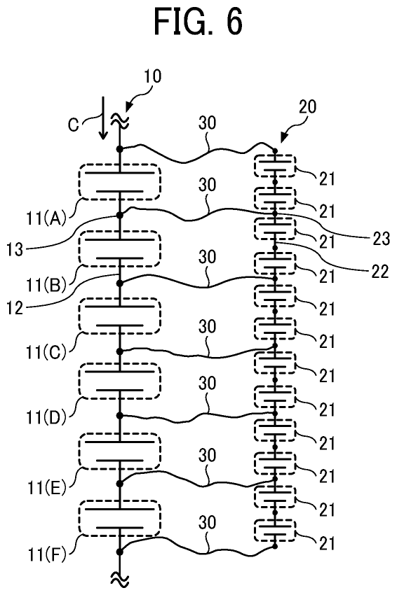

After that, an assembled battery (cell group) in which the six first cells 11 of lithium-ion secondary batteries are connected in series and an assembled battery (cell group) in which twelve cells of nickel-zinc batteries are connected in series were wired in a manner that a set of two cells of nickel-zinc batteries connected in series is connected to a single cell of lithium-ion secondary battery in parallel (see FIG. 6). The obtained power storage system of the lithium-ion secondary batteries and the nickel zinc batteries was defined as Example 1.

An assembled battery (cell group) including lithium-ion secondary batteries of which the charge statuses were adjusted to be different from each other was prepared in advance. Specifically, the assembled battery (cell group) in which the single cells A to F of lithium-ion batteries has been separately charged with a constant current of 1000 mA in a manner that the voltages of the single cells A to F became 2.4 V. 3.1 V. 3.2 V. 3.3 V. 3.5 V, and 3.8 V, respectively, was charged by using a charge-discharge tester (Battery Charge and Discharge System MWCDS-1008-J02 manufactured by MYWAY PLUS COOPERATION) with a current of 1000 mA in a direction of C (see FIG. 6).

### Comparative Example 1

As illustrated in FIG. 2, an assembled battery (cell group) of six cells of lithium-ion secondary batteries included in the power storage system of Example 1 was used as Comparative Example 1.

An assembled battery (cell group) including lithium-ion secondary batteries of which the charge statuses were adjusted to be different from each other was prepared in advance. Specifically, the assembled battery (cell group) in which the single cells G to L of lithium-ion batteries has been separately charged with a constant current of 1000 mA in a manner that the voltages of the single cells G to L became 2.6 V, 3.0 V. 3.2 V. 3.3 V. 3.4 V, and 3.6 V, respectively was charged with a current of 1000 mA in the direction of C (see FIG. 2).

### Regarding First Example

The voltages of the first cells 11 (A to F) of lithium-ion secondary batteries that are six cells connected in series were 2.4 V. 3.1 V. 3.2 V. 3.3 V. 3.5 V, and 3.8 V, respectively, at the start of charging. Then, the charging was continued, and when reaching about 4.0 V, the cell voltage of each of the first cells 11 (A to F) was kept constant so that the charging did not further proceed.

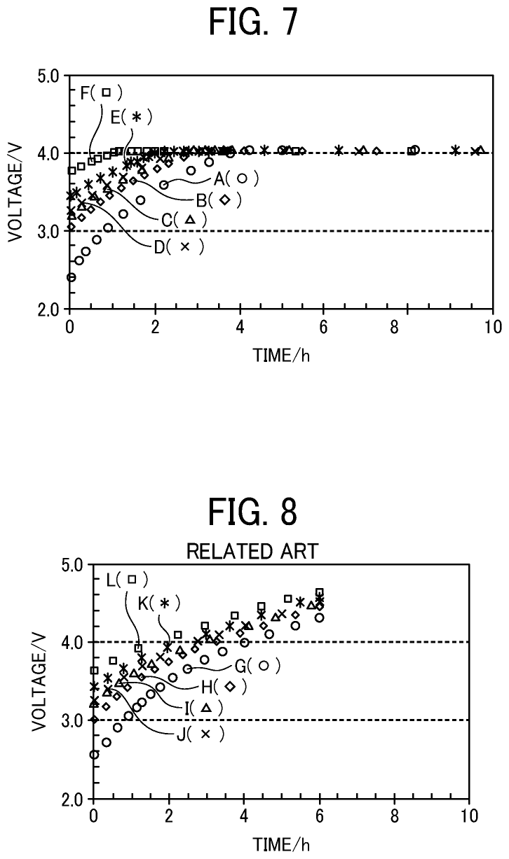

As illustrated in FIG. 7, after the cell voltage reached 4.0V in an order of the lithium-ion secondary batteries F. E. D. C. B, and A, which is an order from ones having higher voltage to lower voltage at the start of charging, the cell voltages of all the lithium-ion secondary batteries became constant at about 4.0 V. In other words, the charge statuses were equalized.

On the other hand, with respect to the assembled buttery (cell group) according to Comparative Example 1, in which the six cells of lithium-ion secondary batteries are connected in series and adjusted to have 2.6 V. 3.0 V. 3.2 V, 3.3 V. 3.4 V, and 3.6 V, respectively, each voltage kept increasing even after reaching 4.0 V by charging, and the charge statuses were not equalized, as illustrated in FIG. 8.

### Examples 2 to 8 and Comparative Examples 2 to 5

### Example 2

In substantially the same manner as the power storage system according to Example 1, each cell of the lithium-ion secondary batteries connected in series was separately charged with a constant current of 1000 mA to have 3.0 V, and each cell of the nickel-zinc batteries connected in series was separately charged with constant current of 320 mA to have 1.5 V.

After that, a power storage system of lithium-ion secondary batteries and nickel zinc batteries is prepared. In the prepared power storage system of the lithium-ion secondary batteries and the nickel zinc batteries, an assembled battery (cell group) of six cells of the lithium-ion secondary batteries connected in series and an assembled battery (cell group) of twelve cells of the nickel-zinc batteries connected in series were wired in a manner that a set of two cells of the nickel-zinc batteries connected in series is connected in parallel to a single cell of the lithium-ion secondary battery.

The power storage system of the lithium-ion secondary batteries and the nickel-zinc batteries was charged with a constant current of 2.5 A (corresponding to 2.0-hour rate with respect to a lithium-ion secondary battery) for 144 minutes to have the maximum power of 60 W in charging, and then left for 10 minutes. After that, the power storage system of the lithium-ion secondary batteries and the nickel-zinc batteries was discharged with a constant current of 2.5 A to have a voltage of 15 V and then left for 10 minutes.

The charge-discharge cycle was repeated in a thermostatic chamber set at 40° C., and a storage power amount of the power storage system of the lithium-ion secondary batteries and the nickel-zinc batteries was measured every 500 cycles. This is Example 2.

The storage power amount of the power storage system of the lithium-ion secondary batteries and the nickel zinc batteries was sufficiently left under a room-temperature environment after charge-discharge cycles, and then discharged with a constant current of 1000 mA until the voltage reached 15 V. After that, the battery was charged with a constant current of 1000 mA for 6 hours to be fully charged. In addition, after the battery was left in a fully-charged state for 1 hour, the battery was discharged with a constant current of 1000 mA until the voltage reached 15 V.

In doing so, an electric power amount consumed from a time of starting of discharging to a time at which the voltage reached 15 V was taken as a storage capacity of the power storage system of the lithium-ion secondary batteries and the nickel zinc batteries.

### Example 3

The power storage system of the lithium-ion secondary batteries and the nickel-zinc batteries, which has the same configuration of the one in Example 2, was charged with a constant current of 1.7 A (corresponding to 3.0-hour rate with respect to a lithium-ion secondary battery) for 24 minutes to have the maximum power of 40 W in charging, and then left for 10 minutes. After that, the power storage system of the lithium-ion secondary batteries and the nickel-zinc batteries was discharged with a constant current of 1.7 A to have a voltage of 15 V and then left for 10 minutes.

The charge-discharge cycle was repeated in a thermostatic chamber set at 40° C., and a storage power amount of the power storage system of the lithium-ion secondary batteries and the nickel-zinc batteries was measured every 500 cycles. This is Example 3.

### Example 4

Two cells of nickel-zinc batteries of 2600 mWh were connected in parallel by welding nickel ribbon wires between the positive electrodes and between the negative electrodes to be fixed by tape to be made as a single cell of nickel-zinc battery of 5200 mWh. An assembled buttery (cell group) of twelve cells of nickel-zinc batteries of 5200 mWh connected in series is connected in parallel to an assembled buttery (cell group) of the six cells of lithium-ion secondary batteries connected in series, and thereby a power storage system is obtained, in substantially the same manner as each of Examples 1 and 2.

The power storage system in which the assembled buttery (cell group) of the six cells of lithium-ion secondary batteries connected in series and the assembled buttery (cell group) of the twelve cells of nickel-zinc batteries of 5200 mWh connected in series are connected in parallel was charged with a constant current of 5.0 A (corresponding to 1.0-hour rate with respect to a lithium-ion secondary battery) for 72 minutes to have the maximum power of 120 W in charging, and then left for 10 minutes. Then, the power storage system of the lithium-ion secondary batteries and the nickel-zinc batteries was discharged with a constant current of 5.0 A to have a voltage of 15 V and then left for 10 minutes.

The charge-discharge cycle was repeated in a thermostatic chamber set at 40° C., and a storage power amount of the power storage system of the lithium-ion secondary batteries and the nickel-zinc batteries was measured every 500 cycles. This is Example 4.

### Example 5

The power storage system of the lithium-ion secondary batteries and the nickel-zinc batteries, which has the same configuration of the one in Example 4, was charged with a constant current of 4.2 A (corresponding to 1.2-hour rate with respect to a lithium-ion secondary battery) for 86.4 minutes to have the maximum power of 100 W in charging, and then left for 10 minutes. After that, the power storage system of the lithium-ion secondary batteries and the nickel-zinc batteries was discharged with a constant current of 4.2 A to have a voltage of 15 V and then left for 10 minutes.

The charge-discharge cycle was repeated in a thermostatic chamber set at 40° C., and a storage power amount of the power storage system of the lithium-ion secondary batteries and the nickel-zinc batteries was measured every 500 cycles. This is Example 5.

### Example 6

The power storage system of the lithium-ion secondary batteries and the nickel-zinc batteries, which has the same configuration of the one in each of Examples 4 and 5, was charged with a constant current of 3.3 A (corresponding to 1.5-hour rate with respect to a lithium-ion secondary battery) for 108 minutes to have the maximum power of 80 W in charging, and then left for 10 minutes. After that, the power storage system of the lithium-ion secondary batteries and the nickel-zinc batteries was discharged with a constant current of 3.3 A to have a voltage of 15 V and then left for 10 minutes.

The charge-discharge cycle was repeated in a thermostatic chamber set at 40° C., and a storage power amount of the power storage system of the lithium-ion secondary batteries and the nickel-zinc batteries was measured every 500 cycles. This is Example 6.

### Example 7

Three cells of nickel-zinc batteries of 2600 mWh were connected in parallel by welding nickel ribbon wires between the positive electrodes and between the negative electrodes to be fixed by tape, and thereby a single cell of nickel-zinc battery of 7800 mWh is made. An assembled buttery (cell group) of twelve cells of nickel-zinc batteries of 7800 mWh connected in series is connected in parallel to an assembled buttery (cell group) of the six cells of lithium-ion secondary batteries connected in series, in substantially the same manner as each of Examples 1 and 2 to obtain a power storage system.

The power storage system in which the assembled buttery (cell group) of the six cells of lithium-ion secondary batteries connected in series and the assembled buttery (cell group) of the twelve cells of nickel-zinc batteries of 7800 mWh connected in series are connected in parallel was charged with a constant current of 6.3 A (corresponding to 0.8-hour rate with respect to a lithium-ion secondary battery) for 57.6 minutes to have the maximum power of 150 W in charging, and then left for 10 minutes. Then, the power storage system of the lithium-ion secondary batteries and the nickel-zinc batteries was discharged with a constant current of 6.3 A to have a voltage of 15 V and then left for 10 minutes.

The charge-discharge cycle was repeated in a thermostatic chamber set at 40° C., and a storage power amount of the power storage system of the lithium-ion secondary batteries and the nickel-zinc batteries was measured every 500 cycles. This is Example 7.

### Example 8

The power storage system of the lithium-ion secondary batteries and the nickel-zinc batteries, which has the same configuration of the one in Example 7, was charged with a constant current of 4.2 A (corresponding to 1.2-hour rate with respect to a lithium-ion secondary battery) for 86.4 minutes to have the maximum power of 100 W in charging, and then left for 10 minutes. After that, the power storage system of the lithium-ion secondary batteries and the nickel-zinc batteries was discharged with a constant current of 4.2 A to have a voltage of 15 V and then left for 10 minutes.

The charge-discharge cycle was repeated in a thermostatic chamber set at 40° C., and a storage power amount of the power storage system of the lithium-ion secondary batteries and the nickel-zinc batteries was measured every 500 cycles. This is Example 8.

### Comparative Example 2

The power storage system of the lithium-ion secondary batteries and the nickel-zinc batteries, which has the same configuration of the one in Comparative Example 1, was charged with a constant current of 2.5 A (corresponding to 2.0-hour rate with respect to a lithium-ion secondary battery) for 144 minutes to have the maximum power of 60 W in charging, and then left for 10 minutes. After that, the power storage system of the lithium-ion secondary batteries and the nickel-zinc batteries was discharged with a constant current of 2.5 A to have a voltage of 15 V and then left for 10 minutes.

The charge-discharge cycle was repeated in a thermostatic chamber set at 40° C., and a storage power amount of the power storage system of the lithium-ion secondary batteries and the nickel-zinc batteries was measured every 500 cycles. This is Comparative Example 2. However, when any cell of the lithium-ion secondary batteries reached 4.4 V, the repetition of charge and discharge was stopped for safety.

### Comparative Example 3

The power storage system of the lithium-ion secondary batteries and the nickel-zinc batteries, which has the same configuration of the one in each of Examples 2 and 3, was charged with a constant current of 3.3 A (corresponding to 1.5-hour rate with respect to a lithium-ion secondary battery) for 108 minutes to have the maximum power of 80 W in charging, and then left for 10 minutes. After that, the power storage system of the lithium-ion secondary batteries and the nickel-zinc batteries was discharged with a constant current of 3.3 A to have a voltage of 15 V and then left for 10 minutes.

The charge-discharge cycle was repeated in a thermostatic chamber set at 40° ° C., and a storage power amount of the power storage system of the lithium-ion secondary batteries and the nickel-zinc batteries was measured every 500 cycles. This is Comparative Example 3.

### Comparative Example 4

The power storage system of the lithium-ion secondary batteries and the nickel-zinc batteries, which has the same configuration of the one in each of Examples 2 and 3 and Comparative Example 3, was charged with a constant current of 4.2 A (corresponding to 1.2-hour rate with respect to a lithium-ion secondary battery) for 86.4 minutes to have the maximum power of 100 W in charging, and then left for 10 minutes. After that, the power storage system of the lithium-ion secondary batteries and the nickel-zinc batteries was discharged with a constant current of 4.2 A to have a voltage of 15 V and then left for 10 minutes. The charge-discharge cycle was repeated in a thermostatic chamber set at 40° C., and a storage power amount of the power storage system of the lithium-ion secondary batteries and the nickel-zinc batteries was measured every 500 cycles. This is Comparative Example 4.

### Comparative Example 5

The power storage system of the lithium-ion secondary batteries and the nickel-zinc batteries, which has the same configuration of the one in each of Examples 4 to 6, was charged with a constant current of 6.3 A (corresponding to 0.8-hour rate with respect to a lithium-ion secondary battery) for 57.6 minutes to have the maximum power of 150 W in charging, and then left for 10 minutes. After that, the power storage system of the lithium-ion secondary batteries and the nickel-zinc batteries was discharged with a constant current of 6.3 A to have a voltage of 15 V and then left for 10 minutes.

The charge-discharge cycle was repeated in a thermostatic chamber set at 40° C., and a storage power amount of the power storage system of the lithium-ion secondary batteries and the nickel-zinc batteries was measured every 500 cycles. This is Comparative Example 5.

Regarding Examples 2 to 8 and Comparative Examples 2 to 5, Table 1 indicates charging performance in repeating of charging and discharging of the power storage system in which the assembled buttery (cell group) of the six cells of lithium-ion secondary batteries connected in series and the assembled buttery (cell group) of the twelve cells of nickel-zinc batteries connected in series are connected in parallel. Specifically, Table 1 indicates a ratio of WB to charge power P, the number of charge-discharge cycles until a storage power amount reaches 90% of the initial value, and the maximum cell voltage difference of the lithium-ion secondary batteries at a time when the storage power amount reaches 90% of the initial value.

TABLE 1

| | | | | | | MAXIMUM |
|---|---|---|---|---|---|---|
| | | | | | | CELL |
| | TOTAL | TOTAL | | | | VOLTAGE |
| | POWER | POWER | | | NUMBER OF | DIFFERENCE |
| | AMOUNT | AMOUNT | | | CHARGE- | (V) OF |
| | W_{A}(Wh) OF | W_{B}(Wh) OF | | | DISCHARGE | LITHIUM-ION |
| | ASSEMBLED | ASSEMBLED | | | CYCLES | SECONDARY |
| | BATTERY OF | BATTERY | | | PERFORMED | BATTERIES AT |
| | SIX CELLS OF | (CELL GROUP) | | | UNTIL | TIME WHEN |
| | LITHIUM- | OF TWELVE | MAXIMUM | | STORAGE | STORAGE |
| | ION | CELLS OF | POWER P(W) | | POWER | POWER |
| | SECONDARY | NICKEL-ZINC | TO BE | | AMOUNT | AMOUNT |
| | BATTERIES | BATTERIES | CHARGED TO | RATIO | REACHES 90% | REACHES 90% |
| | CONNECTED | CONNECTED | ASSEMBLED | OF W_{B} | OF INITIAL | OF INITIAL |
| | IN SERIES | IN SERIES | BATTERY | TO P | AMOUNT | VALUE |
| EXAMPLE 2 | 108 | 30.7 | 60 | 0.5 | 2500 | 0.07 |
| EXAMPLE 3 | 108 | 30.7 | 40 | 0.8 | 3500 | 0.04 |
| EXAMPLE 4 | 108 | 61.4 | 120 | 0.5 | 2500 | 0.05 |
| EXAMPLE 5 | 108 | 61.4 | 100 | 0.6 | 3000 | 0.05 |
| EXAMPLE 6 | 108 | 61.4 | 80 | 0.8 | 3000 | 0.03 |
| EXAMPLE 7 | 108 | 92.2 | 150 | 0.6 | 3500 | 0.03 |
| EXAMPLE 8 | 108 | 92.2 | 100 | 0.9 | 4000 | 0.02 |
| COMPARATIVE | 108 | 0 | 60 | 0 | <500 | >0.6 |
| EXAMPLE 2 | | | | | | |
| COMPARATIVE | 108 | 30.7 | 80 | 0.4 | 1500 | 0.18 |
| EXAMPLE 3 | | | | | | |
| COMPARATIVE | 108 | 30.7 | 100 | 0.3 | 1000 | 0.15 |
| EXAMPLE 4 | | | | | | |
| COMPARATIVE | 108 | 61.4 | 150 | 0.4 | 1000 | 0.16 |
| EXAMPLE 5 | | | | | | |

Regarding the assembled battery (cell group) in which the six cells of lithium-ion secondary batteries are connected in series according to Comparative Example 2, when the number of charge-discharge cycles comes to about 400 cycles (less than 500 cycles), a voltage of one cell among the six cells reached 4.4 V, and the charge and discharge of Comparative Example 2 was terminated due to safety concerns, accordingly. At this time, the maximum cell voltage difference of the lithium-ion secondary batteries exceeded 0.6 V.

In Comparative Example 3, Comparative Example 4, Example 2, and Example 3 in each of which the lithium-ion secondary batteries and the nickel-zinc batteries of 2600 mWh were used, the number of charge-discharge cycles performed until a time when a storage power amount reached 90% of the initial amount increased in this order, and the maximum cell voltage difference after the charge-discharge cycles decreased. From this result, it was found that both the number of charge-discharge cycles and the cell voltage difference were satisfied by setting a ratio of storage power amount WB (Wh) of the nickel-zinc batteries to a charge power P (W) to 0.5 or more.

In addition, in Example 7 and Example 8 in each of which the lithium-ion secondary batteries and the nickel-zinc batteries of 7800 mWh were used, the number of charge-discharge cycles performed until a time when a storage power amount reached 90% of the initial amount increased in this order, and the maximum cell voltage difference after the charge-discharge cycles decreased. From this result, in substantially the same manner as Comparative Examples 2 to 6, it was found that both the number of charge-discharge cycles and the cell voltage difference were satisfied by setting a ratio of storage power amount WB (Wh) of the nickel-zinc batteries to a charge power P (W) to 0.5 or more.

As described above, the power storage system including the lithium-ion secondary batteries and the nickel-zinc batteries in which the ratio of the storage power amount WB (Wh) of the nickel-zinc batteries to the charge power P (W) is 0.5 or more can equally keep the charge statuses between the cells of lithium-ion secondary batteries. In addition, the power storage system can maintain power storage performance in long-term charge-discharge cycles.

The above-described embodiments are illustrative and do not limit the present disclosure. Thus, numerous additional modifications and variations are possible in light of the above teachings. For example, elements and/or features of different illustrative embodiments may be combined with each other and/or substituted for each other within the scope of the present disclosure.

Any one of the above-described operations may be performed in various other ways, for example, in an order different from the one described above.

This patent application is based on and claims priority to Japanese Patent Application No. 2021-113622, filed on Jul. 8, 2021, in the Japan Patent Office, the entire disclosure of which is hereby incorporated by reference herein.

### REFERENCE SIGNS LIST

100 power storage system
10 first cell group
11 first cell
12 lead
13 node
20 second cell group
21 second cell
22 lead
23 node
30 lead

1. A power storage system, comprising:
a first cell group including a plurality of first cells connected in series, each of the plurality of first cells being a non-aqueous secondary battery; and
a second cell group including a plurality of second cells connected in series, each of the plurality of second cells being an aqueous secondary battery,
wherein one or more cells of the plurality of second cells included in the second cell group are connected in parallel to a corresponding one of the plurality of first cells included in the first cell group.

2. The power storage system of claim 1, wherein:
the one or more of the plurality of second cells included in the second cell group have a total charge voltage equal to or less than a charge voltage of the corresponding one of the plurality of first cells included in the first cell group.

3. The power storage system of claim 1, wherein:
the non-aqueous secondary battery includes a lithium-ion secondary battery.

4. The power storage system of claim 3, wherein:
the lithium-ion secondary battery includes a positive electrode including a lithium transition metal oxide as a positive electrode active material, the lithium transition metal oxide including manganese.

5. The power storage system of claim 1, wherein:
the aqueous secondary battery includes a sealed aqueous secondary battery.

6. The power storage system of claim 5, wherein:
the sealed aqueous secondary battery includes a nickel-zinc battery.

7. The power storage system of claim 1, wherein:
the non-aqueous secondary battery is a lithium-ion secondary battery, and
the aqueous secondary battery is a nickel-zinc battery, and
two cells that are the nickel-zinc batteries are connected in parallel to corresponding one cell that is the lithium-ion secondary battery.

8. The power storage system of claim 6, wherein:
the plurality of second cells each of which is the nickel-zinc battery has a total charge power amount that is 0.5 times or more of a charge power amount of the power storage system.

9. A power supply, comprising the power storage system of claim 1.

10. A driving device, comprising the power supply of claim 9.

11. A power control device, comprising the power supply of claim 9.

12. A method for equalizing power storage statuses, the method comprising:
connecting a plurality of first cells in series to form a first cell group, each of the plurality of first cells being a non-aqueous secondary battery;
connecting a plurality of second cells in series to form a second cell group, each of the plurality of second cells being an aqueous secondary battery; and
connecting one or more cells of the plurality of second cells of the second cell group in parallel to a corresponding one of the plurality of first cells of the first cell group.

13. The method of claim 12, wherein:
the one or more of the plurality of second cells included in the second cell group have a total charge voltage equal to or less than a charge voltage of the corresponding one of the plurality of first cells included in the first cell group.

14. The method of claim 12, wherein:
the non-aqueous secondary battery includes a lithium-ion secondary battery.

15. The method of claim 14, wherein:
the lithium-ion secondary battery includes a positive electrode including a lithium transition metal oxide as a positive electrode active material, the lithium transition metal oxide including manganese.

16. The method of claim 12, wherein:
the aqueous secondary battery includes a sealed aqueous secondary battery.

17. The method of claim 16, wherein:
the sealed aqueous secondary battery includes a nickel-zinc battery.

18. The method of claim 12, wherein:
the non-aqueous secondary battery is a lithium-ion secondary battery, and
the aqueous secondary battery is a nickel-zinc battery, and
two cells that are the nickel-zinc batteries are connected in parallel to corresponding one cell that is the lithium-ion secondary battery.

19. The method of claim 17, wherein:
the plurality of second cells each of which is the nickel-zinc battery has a total charge power amount that is 0.5 times or more of a charge power amount of the power storage system.
